(19) United States
(12) Patent Application Publication
(10) Pub. No.: US 2010/0310854 A1
(43) Pub. Date: Dec. 9, 2010

(54) POROUS FILM FOR HEAT-SEALABLE BAG-CONSTITUTING MEMBER, HEAT-SEALABLE BAG-CONSTITUTING MEMBER AND DISPOSABLE BODY WARMER

(75) Inventors: Hiroshi Nagami, Ehime (JP); Kaori Ohnishi, Ehime (JP)

Correspondence Address: EDWARDS ANGELL PALMER & DODGE LLP, P.O. BOX 55874, BOSTON, MA, 02205, US

(73) Assignee: NITTO LIFETEC CORPORATION, Matsuyama-shi (JP)

(21) Appl. No.: 12/735,523

(22) PCT Filed: Jan. 27, 2009
(86) PCT No.: PCT/JP2009/000289

§ 371 Date: Jul. 23, 2010

(30) Foreign Application Priority Data
Feb. 6, 2008 (JP) 2008-026872

(51) Int. Cl. B32B 3/26; C08L 23/06

(52) U.S. Cl. 428/316.6; 521/143

(57) ABSTRACT

A porous film for a heat-sealable bag-constituting member is prepared by stretching an unstretched film to be porous. The unstretched film includes an ultrahigh-molecular-weight polyethylene having a weight-average molecular weight of 30×10⁴ to 250×10⁴, a polyolefin component other than the ultrahigh-molecular-weight polyethylene, and an inorganic filler as essential components, and the content of the ultrahigh-molecular-weight polyethylene is 1 percent by weight or more based on the total amount of polymer components constituting the porous film. Even when produced by stretching at a low draw ratio, the film does not suffer from uneven stretching and shows high productivity. When the film is heat-sealed into a bag, the bag has a high seal strength and does not suffer from edge tear. The film is therefore useful particularly as a bag-constituting member to be heat-sealed into a bag typically as a disposable body warmer.

### TECHNICAL FIELD

The present invention relates to a porous film adopted as a member to be heat-sealed into a bag. More specifically, the present invention relates to a porous film for a heat-sealable bag-constituting member, which does not suffer from uneven stretching even when stretched at a low draw ratio, thereby has excellent productivity, has good appearance, and is satisfactorily air-permeable. It also relates to a bag-constituting member and a disposable body warmer both using the porous film.

### BACKGROUND ART

Porous films are now widely used typically in bag-constituting members for enclosing or housing heaters of disposable body warmers; and in bag-constituting members for housing dehumidifiers, deodorants, or other agents (see, for example, Patent Documents 1 and 2).

Exemplary structures of the disposable body warmers include the structure illustrated in FIG. 4. Specifically, in the structure, two bag-constituting members (front member 6 and back member 7) are subjected to a heat sealing process to form a bag, and a heater 3 containing, for example, an iron powder as a main component is enclosed or housed in the bag. An air-permeable member including a composite member (laminated member) typically of a porous film and a nonwoven fabric is used as at least one of the bag-constituting members (generally as a front member), for satisfactorily feeding oxygen to the heater.

Known examples of the porous film include porous films prepared by extruding a specific blend into a sheet and stretching the sheet to be porous. The blend includes a polymer component and an inorganic filler such as calcium carbonate, in which the polymer component contains a linear low-density polyethylene (hereinafter also referred to as “LLDPE”) as a base polymer and further contains an elastomer component having a relatively low resin density (e.g., an ethylene-propylene-diene terpolymer (EPT or EPDM) or an ethylene-butene-diene terpolymer (EBT)). The elastomer component is added for the purpose typically of the improvements of extrusion workability and stretchability (see, for example, Patent Document 3).

Patent Document 1: Japanese Unexamined Patent Application Publication (JP-A) No. H11(1999)-19113

Patent Document 2: Japanese Unexamined Patent Application Publication (JP-A) No. 2002-36471

Patent Document 3: Japanese Patent No. 2602016

### Disclosure of Invention

### Problems to be Solved by the Invention

The porous films composed of LLDPE and EPT (or LLDPE and EBT) tend to tear at high temperatures and are thereby susceptible to edge tear when the porous films are heat-sealed under strong or strict conditions (e.g., under high-temperature conditions) into bags. The edge tear is a phenomenon in which the film tears at the boundary region between a heat-sealed section and a non-heat-sealed section. In contrast, when the porous films are heat-sealed under excessively weak conditions into bags, the bags have insufficient seal strengths. The porous films thereby show insufficient productivity, because appropriate conditions for heat sealing of the porous films are small in range. The porous films also have problems such that they often suffer from pin holes due to gel formation, they have high cost, and they show insufficient heat sealability.

The present inventors made investigations on porous films using an ethylene-α-olefin copolymer instead of EPT or EBT and found that the use of the ethylene-α-olefin copolymer improves the heat sealability and suppresses the gel formation while reducing costs. However, they further found that the edge tear problem still remains unsolved even when the ethylene-α-olefin copolymer is used. Additionally, they found that a film containing such an ethylene-α-olefin copolymer should be stretched at a high draw ratio to give a porous film, and this causes another problem of insufficient productivity caused typically by film break or generating holes, because the unstretched film using the ethylene-α-olefin copolymer shows insufficient stretchability, and when the film is stretched at a low draw ratio to form a porous film, the film is not stretched uniformly and suffers from uneven stretching, and this impairs appearance and air permeability of the porous film.

Specifically, under present circumstances, there has not yet been provided a porous film which is available at low cost, which excels in stretchability and heat sealability, which is resistant to edge tear, and which is suitable as a heat-sealable bag-constituting member.

Accordingly, an object of the present invention is to provide a high-quality porous film for a heat-sealable bag-constituting member, which can be produced with satisfactory productivity and does not suffer from uneven stretching even when formed by stretching at a low draw ratio, and, when heat-sealed into a bag, the bag has a high seal strength and is resistant to edge tear.

### Means for Solving the Problems

After intensive investigations to achieve the object, the present inventors have found that a specific porous film can be stretched uniformly even at a low draw ratio, and is suitable as a heat-sealable bag-constituting member that gives a bag having a high heat-seal strength and is resistant to edge tear. This specific porous film is prepared by stretching an unstretched film into a porous film, which unstretched film includes, as essential components, an inorganic filler and a polymer component including a polyolefin (e.g., a linear low-density polyethylene) and an ultrahigh-molecular-weight polyethylene having a specific molecular weight in a specific content. The present invention has been made based on these findings.

Specifically, the present invention provides, in an embodiment, a porous film for a heat-sealable bag-constituting member, which is prepared by stretching an unstretched film to be porous, in which the porous film includes an ultrahigh-molecular-weight polyethylene having a weight=average molecular weight of 30×10⁴ to 250×10⁴, a polyolefin component other than the ultrahigh-molecular-weight polyethylene, and an inorganic filler as essential components, and the content of the ultrahigh-molecular-weight polyethylene is 1 percent by weight or more based on the total amount of polymer components constituting the porous film.

In the porous film for a heat-sealable bag-constituting member, the polyolefin component other than the ultrahigh-molecular-weight polyethylene may mainly include one polyolefin selected from the group consisting of a polypropylene, a linear low-density polyethylene having a weight-average molecular weight of less than 30×10⁴, and a high-density polyethylene having a weight-average molecular weight of less than 30×10⁴.

In the porous film for a heat-sealable bag-constituting member, the polyolefin component other than the ultrahigh-molecular-weight polyethylene may further include an ethylene-α-olefin copolymer having a weight-average molecular weight of less than 30×10⁴ and a density of less than 0.90 g/cm³.

The present invention provides, in another embodiment, a heat-sealable bag-constituting member which includes a composite material of the porous film for a heat-sealable bag-constituting member, and another air-permeable material.

The heat-sealable bag-constituting member may be adopted to at least one use selected from the group consisting of use for a disposable body warmer, use for housing a dehumidifier, use for housing a deodorant, use for housing a flavoring agent, and use for housing a deoxidizer.

The present invention further provides, in yet another embodiment, a disposable body warmer including the heat-sealable bag-constituting member for a disposable body warmer, as at least part of bag-constituting members.

### Advantages

The porous film for a heat-sealable bag-constituting member according to the present invention is resistant to uneven stretching even when formed by stretching at a low draw ratio, thereby can be produced with satisfactory productivity, has good appearance, and is highly air-permeable. When the porous film is heat-sealed into a bag, the bag has a high seal strength and is resistant to “edge tear” (a phenomenon where the film tears at the boundary region between a heat-sealed section and a non-heat-sealed section). The porous film is therefore useful as a bag-constituting member which will be heat-sealed into a bag, typically in a disposable body warmer use.

### BRIEF DESCRIPTION OF DRAWINGS

FIG. 1 is a schematic cross-sectional view illustrating a bag-constituting member as an embodiment of the present invention.

FIG. 2 is a schematic cross-sectional view illustrating a disposable body warmer as an embodiment of the present invention.

FIG. 3 is a schematic plan view illustrating the disposable body warmer as an embodiment of the present invention, when viewed from above.

FIG. 4 is a schematic cross-sectional view illustrating an exemplary common adhesive-patch disposable body warmer.

### REFERENCE NUMERALS

1 bag-constituting member (air-permeable bag-constituting member) according to the present invention

11 porous film

12 adhesive layer

13 nonwoven fabric

2 other bag-constituting member (non-air-permeable bag-constituting member)

21 substrate

22 pressure-sensitive adhesive layer

3 heater

4 heat-sealed section

5 boundary region between heat-sealed section and non-heat-sealed section

6 bag-constituting member (front member)

7 bag-constituting member (back member)

71 substrate

72 pressure-sensitive adhesive layer

### BEST MODES FOR CARRYING OUT THE INVENTION

A porous film for a heat-sealable bag-constituting member according to an embodiment of the present invention (hereinafter also simply referred to as the “porous film according to the present invention”) will be illustrated in detail below. The porous film according to the present invention includes, as essential components, an ultrahigh-molecular-weight polyethylene having a weight-average molecular weight of 30×10⁴ to 250×10⁴ (hereinafter also simply referred to as the “ultrahigh-molecular-weight polyethylene”), a polyolefin component other than the ultrahigh-molecular-weight polyethylene (another polyolefin component than the ultrahigh-molecular-weight polyethylene), and an inorganic filler.

The ultrahigh-molecular-weight polyethylene for use in the porous film according to the present invention is a polyethylene having a weight-average molecular weight of 30×10⁴ to 250×10⁴. The ultrahigh-molecular-weight polyethylene is not limited, as long as being a polymer containing ethylene as a main monomer component, and may be either an ethylene homopolymer or a copolymer of ethylene and an α-olefin monomer having 3 to 8 carbon atoms. Among them, ethylene-propylene copolymers are preferred. The content of ethylene monomer units in the ultrahigh-molecular-weight polyethylene is preferably 90 to 100 percent by mole based on the total moles of monomer units constituting the polyethylene.

The weight-average molecular weight of the ultrahigh-molecular-weight polyethylene is 30×10⁴ to 250×10⁴, preferably 40×10⁴ to 200×10⁴, and more preferably 50×10⁴ to 150×10⁴. An ultrahigh-molecular-weight polyethylene, if having a molecular weight of less than 30×10⁴, does not effectively suppress edge tear after heat sealing and does not effectively suppresses uneven stretching when the film is produced by stretching at a low draw ratio, and when an ethylene-α-olefin copolymer is used in combination with this ultrahigh-molecular-weight polyethylene, the porous film may show inferior productivity, poor appearance, and insufficient air permeability. In contrast, an ultrahigh-molecular-weight polyethylene, if having a molecular weight of more than 250×10⁴, causes extrusion failure and/or defects such as fisheyes. The weight-average molecular weight herein can be measured through a gel permeation chromatography (GPC) technique. Specifically, the weight-average molecular weight can be measured by a method mentioned later.

The density of the ultrahigh-molecular-weight polyethylene is preferably 0.92 to 0.96 g/cm³ and more preferably 0.93 to 0.955 g/cm³. As used herein the “density” refers to a density determined according to International Organization for Standardization (ISO) Standards 1183 (Japanese Industrial Standards (JIS) K 7112).

The ultrahigh-molecular-weight polyethylene plays a role in suppression of edge tear occurring when the porous film is heat-sealed. Particularly when the porous film further contains an ethylene-α-olefin copolymer in addition to the base polymer (main polymer component), the ultrahigh-molecular-weight polyethylene also plays a role in improvement of stretchability of the porous film. This allows the porous film to be resistant to uneven stretching even when formed by stretching at a low draw ratio. The content of the ultrahigh-molecular-weight polyethylene in the porous film according to the present invention is 1 percent by weight or more, preferably 1 to 40 percent by weight, more preferably 5 to 30 percent by weight, and still more preferably 10 to 20 percent by weight, based on the total amount of polymer components constituting the porous film (100 percent by weight). The ultrahigh-molecular-weight polyethylene, if present in a content of less than 1 percent by weight, does not effectively suppress uneven stretching when stretched at a low draw ratio and does not effectively suppress edge tear. The ultrahigh-molecular-weight polyethylene, if present in a content of more than 40 percent by weight, may cause extrusion failure and/or defects such as fisheyes.

The polyolefin component other than the ultrahigh-molecular-weight polyethylene (the other polyolefin component than the ultrahigh-molecular-weight polyethylene), for use in the porous film according to the present invention, is a main polymer component (base polymer) constituting the porous film and significantly affects the properties of the porous film, such as strength properties, film-formability (stretchability), and heat sealability.

The polyolefin component other than the ultrahigh-molecular-weight polyethylene preferably contains, as a main component, one polyolefin selected from the group consisting of a polypropylene, a linear low-density polyethylene having a weight-average molecular weight of less than 30×10⁴, and a high-density polyethylene having a weight-average molecular weight of less than 30×10⁴, of which the linear low-density polyethylene is preferred. The polyolefin component other than the ultrahigh-molecular-weight polyethylene may include two or more different polyolefins as a mixture as the main component. The polyolefin component other than the ultrahigh-molecular-weight polyethylene more preferably further includes an ethylene-α-olefin copolymer having a weight-average molecular weight of less than 30×10⁴ and a density of less than 0.90 g/cm³ (hereinafter also simply referred to as the “ethylene-α-olefin copolymer”) as a component, in addition to the main component.

The content of the polyolefin component other than the ultrahigh-molecular-weight polyethylene in the porous film according to the present invention is preferably 60 to 99 percent by weight and more preferably 70 to 95 percent by weight, based on the total amount of polymer components constituting the porous film (100 percent by weight). The content of the polyolefin as the main component (e.g., a linear low-density polyethylene having a weight-average molecular weight of less than 30×10⁴) in the porous film is preferably 50 to 90 percent by weight and more preferably 65 to 85 percent by weight, based on the total amount of polymer components constituting the porous film (100 percent by weight). The polyolefin as the main component, if present in a content of less than 50 percent by weight, may not help the film to have sufficient stretchability. In contrast, the polyolefin, if present in a content of more than 90 percent by weight, may adversely affect the extrusion properties and stretchability or may cause edge tear when the porous film is heat sealed and the resulting porous film may show poor workability. The content of the ethylene-α-olefin copolymer in the porous film is preferably 5 to 30 percent by weight and more preferably 10 to 20 percent by weight, based on the total amount of polymer components constituting the porous film (100 percent by weight). The ethylene-α-olefin copolymer, if present in a content of less than 5 percent by weight, may not satisfactorily help the porous film to have sufficient heat sealability. The ethylene-α-olefin copolymer, if present in a content of more than 30 percent by weight, may adversely affect stretchability, and the porous film may often suffer from uneven stretching when formed by stretching at a low draw ratio.

The linear low-density polyethylene is a linear polyethylene which is prepared through polymerization of ethylene and an α-olefin Monomer having 4 to 8 carbon atoms and which has short branches. The branches each preferably have 1 to 6 carbon atoms in length. Preferred α-olefin monomers for use in the linear low-density polyethylene include 1-butene, 1-octene, 1-hexene, and 4-methylpentene-1. The content of ethylene monomer units in the linear low-density polyethylene is preferably 90 percent by mole or more of the total constitutional monomer units. Of such linear low-density polyethylenes, preferred for further higher heat sealability are so-called metallocene-catalyzed linear low-density polyethylenes (metallocene-catalyzed LLDPEs) which are prepared by the catalysis of metallocene catalysts.

The density of the linear low-density polyethylene is preferably 0.90 g/cm³ or more and less than 0.93 g/cm³, and more preferably 0.91 to 0.92 g/cm³.

The weight-average molecular weight of the linear low-density polyethylene is not critical, as long as being less than 30×10⁴, but is preferably 3×10⁴ to 20×10⁴ and more preferably 5×10⁴ to 6×10⁴.

Though not critical, the melt flow rate (MFR) of the linear low-density polyethylene at 190° C. is preferably 1.0 to 5.0 (grams per 10 minutes (g/10-min)) and more preferably 2.0 to 4.0 (g/10-min). The melt flow rate (MFR) herein can be measured according to ISO 1133 (JIS K 7210).

The high-density polyethylene can be any of known or common high-density polyethylenes having a density of 0.93 g/cm³ or more, and preferably 0.942 to 0.960 g/cm³, as determined according to ISO 1183. The weight-average molecular weight of the high-density polyethylene is not critical, as long as being less than 30×10⁴, but is preferably 3×10⁴ to 20×10⁴ and more preferably 5×10⁴ to 6×10⁴. Though not critical, the melt flow rate (MFR) of the high-density polyethylene at 190° C. is preferably 1.0 to 5.0 (g/10-min) and more preferably 2.0 to 4.0 (g/10-min).

The polypropylene for use herein can be any of known or common polypropylenes such as a propylene homopolymer and a propylene-α-olefin copolymer. The α-olefin component in the propylene-α-olefin copolymer can be adequately chosen from among α-olefins having 4 to 10 carbon atoms. The content of propylene monomer units in the propylene-α-olefin copolymer is preferably 90 percent by mole or more based on the total amount of constitutional monomer units.

Though not critical, the weight-average molecular weight of the polypropylene is preferably less than 30×10⁴ and more preferably 3×10⁴ to 20×10⁴. Also though not critical, the melt flow rate (MFR) of the polypropylene at 190° C. is preferably 1.0 to 5.0 (g/10-min) and more preferably 2.0 to 4.0 (g/10-min).

The ethylene-α-olefin copolymer having a weight-average molecular weight of less than 30×10⁴ and a density of less than 0.90 g/cm³ is additionally used as the polyolefin component according to necessity. This ethylene-α-olefin copolymer is a copolymer of ethylene and an α-olefin monomer having 4 to 8 carbon atoms. Among such ethylene-α-olefin copolymers, an ethylene-α-olefin copolymerized elastomer using butene-1 as the α-olefin is preferred. The content of ethylene monomer units in the ethylene-α-olefin copolymer is preferably 60 to 95 percent by mole and more preferably 80 to 90 percent by mole based on the total amount of constitutional monomer units. The ethylene-α-olefin copolymer plays a role in further improvement of heat sealability of the porous film.

The density of the ethylene-α-olefin copolymer is less than 0.90 g/cm³, preferably 0.86 to 0.89 g/cm³, and more preferably 0.87 to 0.89 g/cm³.

The weight-average molecular weight of the ethylene-α-olefin copolymer is less than 30×10⁴, preferably 5×10⁴ to 20×10⁴, and more preferably 8×10⁴ to 15×10⁴.

Though not critical, the melt flow rate (MFR) of the ethylene-α-olefin copolymer at 190° C. is preferably 1.0 to 5.0 (g/10-min) and more preferably 2.0 to 4.0 (g/10-min).

The inorganic filler for use in the porous film according to the present invention plays such a role that the inorganic filler allows voids (pores) around the filler as a result of stretching and thereby allows the film to be porous. Exemplary inorganic fillers include talc, silica, stone powder, zeolite, alumina, aluminum powder, and iron powder; as well as metal carbonates such as calcium carbonate, magnesium carbonate, calcium/magnesium carbonate, and barium carbonate; metal sulfates such as magnesium sulfate and barium sulfate; metal oxides such as zinc oxide, titanium oxide, and magnesium oxide; metal hydroxides such as aluminum hydroxide, magnesium hydroxide, zirconium hydroxide, calcium hydroxide, and barium hydroxide; and metal hydrates (hydrated metallic compounds) such as a hydrate of magnesium oxide and nickel oxide, and a hydrate of magnesium oxide and zinc oxide. Though not critical, the inorganic filler may be, for example, tabular or granular in its shape, but is preferably granular (particle-form) so as to form voids (pores) more satisfactorily as a result of stretching. Specifically, inorganic particles (inorganic microparticles) including calcium carbonate are preferred as the inorganic filler.

Though not critical, the particle size (average particle diameter) of the inorganic filler (inorganic microparticles) is, for example, preferably 0.1 to 10 μm and more preferably 0.5 to 5 μm. The inorganic filler, if having a particle size of less than 0.1 μm, may not satisfactorily contribute to the formation of voids. In contrast, the inorganic filler, if having a particle size of more than 10 μm, may cause break during film formation and may cause poor appearance.

Though not critical, the content of the inorganic filler (inorganic microparticles) is, for example, preferably 50 to 150 parts by weight and more preferably 80 to 120 parts by weight per 100 parts by weight of the total amount of polymer components constituting the porous film. The inorganic filler, if present in a content of less than 50 parts by weight, may not satisfactorily contribute to the formation of voids. In contrast, the inorganic filler, if present in a content of more than 150 parts by weight, may cause break during film formation and may cause poor appearance.

The porous film according to the present invention may further contain various additives within ranges not adversely affecting the advantages of the present invention. Exemplary additives include colorants, age inhibitors, antioxidants, ultraviolet absorbers, flame retardants, and stabilizers.

The porous film according to the present invention can be prepared by a film formation process using melting state, such as T-die process or tubular film process. Of such processes, T-die process is preferred. Typically, the porous film may be prepared by mixing and dispersing the ultrahigh-molecular-weight polyethylene, the polyolefin component other than the ultrahigh-molecular-weight polyethylene, the inorganic filler, and, according to necessity, additives using a twin-screw kneader/extruder to give pellets, and melting and extruding the pellets using a single-screw extruder to give an unstretched film, and stretching the unstretched film uniaxially or biaxially into a porous film. The porous film, when to be a multilayer film, is preferably produced through coextrusion.

The extrusion temperature in, the production of the porous film is preferably 180° C. to 250° C., more preferably 200° C. to 250° C., and still more preferably 210° C. to 240° C. The haul-off of the unstretched film is performed at a speed of preferably 5 to 25 meters per minute (m/min) and at a haul-off roll temperature (cooling temperature) of preferably 5° C. to 30° C. and more preferably 10° C. to 20° C.

The unstretched film for use in the porous film according to the present invention is resistant to uneven stretching and shows satisfactory stretchability even when stretched at a relatively low draw ratio (e.g., less than 5 times, particularly less than 4 times). The unstretched film thereby gives a porous film through film formation under stable conditions at a relatively low draw ratio, and the porous film does not suffer from uneven stretching. The stretchability is evaluated, for example, in the following manner. The unstretched film is uniaxially stretched at a stretching temperature (for example, 80° C.) and a stress-strain curve is plotted; and a stress increase ratio at elongations from 2.5 times to 4.0 times (“stress at an elongation of 4.0 times”/“stress at an elongation of 2.5 times”) is determined based on the stress-strain curve. When the film has a stress increase ratio of 1.02 or more (more preferably 1.05 or more), the film is evaluated as having satisfactory stretchability. An unstretched film having such satisfactory stretchability can be obtained by producing the unstretched film from raw materials described herein according to the above-mentioned production process.

The uniaxial or biaxial stretching (sequential biaxial stretching or simultaneous biaxial stretching) of the unstretched film can be performed according to a known or common stretching procedure such as stretching using a roll or stretching using a tenter. The stretching temperature is preferably 50° C. to 100° C., and more preferably 60° C. to 90° C. The draw ratio (in one direction) is preferably 2 to 5 times, and more preferably 3 to 4 times, from the viewpoint of stably forming a satisfactorily porous film. The draw ratio by area in the biaxial stretching is preferably 2 to 10 times, and more preferably 3 to 7 times.

Though not critical, the thickness of the porous film is, for example, preferably 30 to 150 μm and more preferably 50 to 120 μm.

The porous film according to the present invention is used as members for constituting bags (bag-constituting members). Above all, the porous film is preferably used as an air-permeable bag-constituting member, because the porous film has satisfactory air permeability and thereby satisfactorily supplies oxygen to the heater. The porous film according to the present invention can be used alone, or two or more plies of the porous film according to the present invention may be combined to form a bag-constituting member. However, the porous film according to the present invention is preferably combined with (hybridized with) another air-permeable material (other air-permeable material) to form a bag-constituting member.

Examples of the other air-permeable material to be combined with the porous film according to the present invention include fibrous materials such as nonwoven fabrics; and other porous films than the porous film according to the present invention. Among them, nonwoven fabrics are preferred as showing good feel, smooth texture, and a high strength. The nonwoven fabric for use herein is not particularly limited and includes known or common nonwoven fabrics including those of natural fibers, and those of synthetic resins, such as nylon nonwoven fabrics (polyamide nonwoven fabrics), polyester nonwoven fabrics, polyolefin nonwoven fabrics, and rayon nonwoven fabrics. The nonwoven fabric may be prepared according to any process and can be, for example, either a nonwoven fabric prepared by spunbonding (spunbonded nonwoven fabric) or a nonwoven fabric prepared by spunlacing (spunlace nonwoven fabric). The nonwoven fabric may have either a single-layer structure or a multilayer structure. The fiber diameter, fiber length, mass per unit area (METSUKE), and other parameters of the nonwoven fabric are not particularly limited. However, the nonwoven fabric preferably has a mass per unit area of about 20 to 100 g/m² and more preferably about 20 to 80 g/m², for further satisfactory processability and cost efficiency. The nonwoven fabric may be composed of a fiber of one type or fibers of different types.

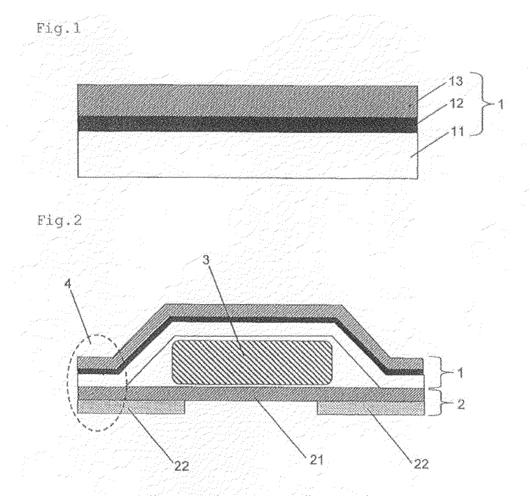

FIG. 1 is a schematic cross-sectional view showing an exemplary bag-constituting member using the porous film according to the present invention. The bag-constituting member 1 according to the present invention includes a porous film 11 according to the present invention and a nonwoven fabric 13 bonded with each other through an adhesive layer 12.

In the bag-constituting member, the way to laminate the porous film and another air-permeable material (for example, nonwoven fabric) is not particularly limited, but they are preferably bonded with each other through an adhesive, as illustrated above. Though not particularly limited, exemplary adhesives include rubber adhesives such as natural rubber and styrenic elastomers; urethane adhesives (acrylic urethane adhesives); acrylic adhesives; silicone adhesives; polyester adhesives; polyamide adhesives; epoxy adhesives; vinyl alkyl ether adhesives; fluorine-containing adhesives; and other known adhesives. Each of different adhesives can be used alone or in combination. Among them, amide adhesives and polyester adhesives are preferred.

The adhesives for use herein can be adhesives of every form, of which hot-melt (thermofusible) adhesives are preferred, because they can be applied by heating and melting without the use of solvents, can be directly applied even to nonwoven fabrics to form an adhesive layer, and, when the member is heat-sealed, can give a further higher adhesive strength in the heat-sealed section. Specifically, the adhesives are preferably amide or polyester hot-melt adhesives, of which amide or polyester thermoplastic hot-melt adhesives are more preferred.

The specific way to laminate the porous film and the nonwoven fabric varies depending typically on the type of the adhesive and is not particularly limited. Typically, when a hot-melt adhesive is used, the lamination is preferably carried out by applying the adhesive to a nonwoven fabric, and bonding porous film thereonto. The application can be carried out according to any known or common procedure used for the application of hot-melt adhesives. The application is preferably carried out by spray coating, stripe coating, or dot coating, typically for maintaining the air permeability. Though not critical, the mass of coating (in terms of solids content) of the adhesive is preferably 0.5 to 20 g/m² and more preferably 1 to 8 g/m², from the viewpoints of adhesion of the heat-sealed section upon the formation of bag typically of a body warmer and economical efficiency.

In the bag-constituting member according to the present invention, the porous film and the nonwoven fabric may be entirely completely bonded (sealed) or bonded only in the heat-sealed section. It is also acceptable that the heat-sealed section is firmly bonded, and the other portions than the heat-sealed section are temporarily adhered and laminated (this state is hereinafter simply referred to as “temporary adhesion”). In a preferred embodiment, the porous film and the nonwoven fabric are laminated in temporary adhesion in the other portions than the heat-sealed section, for further pleasant touch (further satisfactory feel). As used herein the “temporary adhesion” refers to a state where the porous film and the nonwoven fabric sufficiently adhere to each other during production and processing of the bag-constituting member and disposable body warmer, but they are capable of detaching from each other by the action of external force applied upon the use of the disposable body warmer. More specifically, “temporary adhesion” refers to such a state that the peel force between the porous film and the nonwoven fabric before heat sealing is 0.2 newtons per 25 millimeters (N/25-mm) or less, as determined in a T-peel test at a tensile speed of 300 mm/min. The peel force is preferably 0.1 N/25-mm or less, and more preferably 0.0001 to 0.1 N/25-mm. When the porous film and the nonwoven fabric adhere with each other with a peel force within the above-specified range (i.e., when they are in temporary adhesion), the disposable body warmer can be satisfactorily produced and processed, because the two layers are bonded with each other at a sufficient adhesive strength during production and processing. On the other hand, when the body warmer is expanded or contracted, the porous film and the nonwoven fabric detach from each other, and the body warmer shows further pleasant feel and texture.

The bag-constituting member is a heat-sealable bag-constituting member which is heat-sealed into a bag. The bag-constituting member according to the present invention is preferably used in the bag, because the bag-constituting member uses the porous film according to the present invention, is thereby satisfactorily permeable to air, is satisfactorily heat-sealable, and is resistant to edge tear after heat sealing. The bag has only to include the bag-constituting member according to the present invention at least as part thereof. Specifically, the bag may be formed by heat sealing two or more plies of the bag-constituting members according to the present invention with each other or may be formed by heat sealing the bag-constituting member according to the present invention with another bag-constituting member (other bag-constituting member).

The bag-constituting member according to the present invention can be adopted to a variety of uses according to the contents to be enclosed or housed in the bag. For example, the bag-constituting member is adopted to housing typically of dehumidifiers, deodorants, flavoring agents, and deoxidizers. It is preferably adopted in a disposable body warmer which houses a heater (heating element, exothermic material).

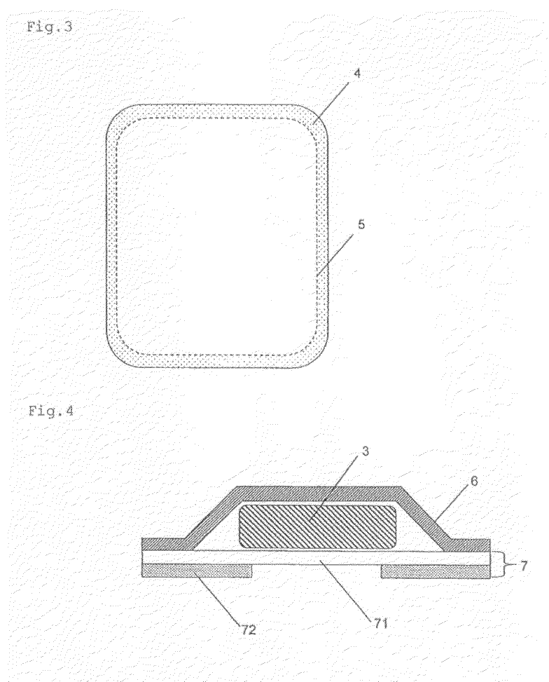

A disposable body warmer according to the present invention can be formed by heat sealing the bag-constituting members according to the present invention with each other or heat sealing the bag-constituting member according to the present invention with another bag-constituting member, into a bag; and enclosing or housing a heater in the bag. FIGS. 2 and 3 are a schematic cross-sectional view and a schematic plan view when viewed from above, respectively, illustrating an exemplary disposable body warmer using the bag-constituting member according to the present invention and another bag-constituting member. The disposable body warmer according to the present invention illustrated in FIGS. 2 and 3 includes a bag and a heater 3 housed in the bag. The bag is formed by heat sealing the bag-constituting member 1 according to the present invention with another bag-constituting member (other bag-constituting member) 2 at an end portion (heat-sealed section 4) to form a bag. The other bag-constituting member 2 includes a substrate 21 and a pressure-sensitive adhesive layer 22. In such a body warmer (disposable body warmer) including a pressure-sensitive adhesive layer on one side thereof and intended to be applied to an adherend such as clothing as with one illustrated above, the bag-constituting member according to the present invention is preferably used at least as a member (so-called front member) opposite to the side to face the adherend, for supplying oxygen to the heater further sufficiently.

The other bag-constituting member (other bag-constituting member than the bag-constituting member according to the present invention, which is to be sealed with the bag-constituting member according to the present invention into a bag) is not particularly limited and can be any of known or common air-permeable or non-air-permeable bag-constituting members. When adopted to uses where the bag is applied typically to clothing (e.g., as a disposable body warmer to be applied to a body, clothing, or footwear), the other bag-constituting member is preferably a bag-constituting member having a pressure-sensitive adhesive layer, such as a bag-constituting member including a substrate and a pressure-sensitive adhesive layer. The bag-constituting member of this type is also available as commercial products such as “Nitotac” supplied by Nitto Lifetec Corporation. “Nitotac” is a pressure-sensitive adhesive sheet for body warmers and is a laminate of a heat-sealable polyolefin substrate and a styrene-isoprene-styrene block copolymer (SIS) pressure-sensitive adhesive layer.

The substrate preferably includes at least one of a heat-sealable layer, a fibrous layer (for example, nonwoven fabric layer), and a film layer. More specific examples of the substrate include a laminate of a heat-sealable layer (inclusive of heat-sealable film layer) and a fibrous layer; and a laminate of a heat-sealable layer and a non-heat-sealable film layer.

A nonwoven fabric for use in the nonwoven fabric layer can be any of the nonwoven fabrics mentioned above.

The heat-sealable layer can be formed from a heat-sealable resin composition containing one or more resins having heat sealability (heat-sealable resins). Though not limited, the heat-sealable resins are preferably olefinic resins (polyolefins). The olefinic resins can be any resins that contain at least an olefinic component as a monomer component. Examples of the olefinic component include α-olefins such as ethylene, propylene, butene-1, pentene-1, hexene-1, 4-methyl-pentene-1, heptene-1, and octene-1. Specific examples of the olefinic resins include ethylenic resins such as low-density polyethylenes, linear low-density polyethylenes, high-density polyethylenes, ethylene-vinyl acetate copolymers, and ethylene/α-olefin copolymers (for example, ethylene-propylene copolymers); propylene resins such as polypropylenes and propylene-α-olefin copolymers; polybutene resins such as polybutene-1; and poly-4-methylpentene-1. Exemplary olefinic resins usable herein further include copolymers of ethylene and unsaturated carboxylic acids, such as ethylene-acrylic acid copolymers and ethylene-methacrylic acid copolymers; ionomers; copolymers of ethylene and (meth)acrylic esters, such as ethylene-methyl acrylate copolymers, ethylene-ethyl acrylate copolymers, and ethylene-methyl methacrylate copolymers; and ethylene-vinyl alcohol copolymers. Ethylenic resins are preferred as the olefinic resin for use in the heat-sealable layer, of which a low-density polyethylene, a linear low-density polyethylene, and an ethylene/α-olefin copolymer are more preferred.

An α-olefin in the ethylene/α-olefin copolymer for use in the heat-sealable layer is not limited, as long as being an α-olefin other than ethylene, but examples thereof include α-olefins having 3 to 10 carbon atoms, such as propylene, butene-1, pentene-1, hexene-1, 4-methyl-pentene-1, heptene-1, and octene-1. Specific examples of the ethylene/α-olefin copolymer therefore include ethylene-propylene copolymers and ethylene-(butene-1) copolymers. Independently, an α-olefin in the propylene-α-olefin copolymer for use as the olefinic resin in the heat-sealable layer can be chosen as appropriate typically from among α-olefins having 4 to 10 carbon atoms.

Each of different heat-sealable resins can be used alone or in combination.

Of such heat-sealable resin compositions, preferred are olefinic resin compositions containing at least an ethylene/α-olefin copolymer as an olefinic resin, of which olefinic resin compositions containing both an ethylene/α-olefin copolymer and at least one of a low-density polyethylene and a linear low-density polyethylene are more preferred. Though not critical, the content of the ethylene/α-olefin copolymer in the olefinic resin compositions containing at least the ethylene/α-olefin copolymer or in the olefinic resin compositions containing both the ethylene/α-olefin copolymer and at least one of a low-density polyethylene and a linear low-density polyethylene can be chosen within the ranges of, for example, 5 percent by weight or more, preferably 10 to 50 percent by weight, and more preferably 15 to 40 percent by weight, based on the total weight of the olefinic resins.

For carrying out heat sealing at a lower temperature and at a higher speed, it is effective to use heat-sealable resins having lower melting points. Among such resins, low-density polyethylenes prepared by the catalysis of metallocene catalysts are most effective.

The heat-sealable layer may have either a single-layer structure or multilayer structure.

The film layer can be any of commonly used film layers. Exemplary material resins for constituting the film layer include polyester resins and olefinic resins. Among them, olefinic resins are preferred, because they are available at low cost and have satisfactory flexibility. Resins as with those exemplified in the heat-sealable layer can be used as the olefinic resins. The film layer may be either a single-layer film or a multilayer film including two or more layers. Independently, the film layer may be either a non-oriented film, or a uniaxially or biaxially oriented film, but is preferably a non-oriented film.

The thickness of the substrate is not particularly limited and is, for example, about 10 to about 500 μm, preferably about 12 to about 200 μm, and more preferably about 15 to about 100 μm. The substrate may have undergone one or more treatments such as backing and antistatic treatment according to necessity.

The pressure-sensitive adhesive layer provided in the other bag-constituting member plays a role in the affixation of the bag to an adhered upon use. Though not limited, exemplary pressure-sensitive adhesives for constituting the pressure-sensitive adhesive layer include known pressure-sensitive adhesives such as rubber pressure-sensitive adhesives, urethane pressure-sensitive adhesives (acrylic urethane pressure-sensitive adhesives), acrylic pressure-sensitive adhesives, silicone pressure-sensitive adhesives, polyester pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. Each of different pressure-sensitive adhesives can be used alone or in combination. Among them, rubber and urethane (acrylic urethane) pressure-sensitive adhesives are especially preferred.

Examples of the rubber pressure-sensitive adhesives include rubber pressure-sensitive adhesives containing any of natural rubbers and synthetic rubbers as a base polymer. Exemplary rubber pressure-sensitive adhesives containing a synthetic rubber as a base polymer include styrenic rubbers (also called styrenic elastomers) such as styrene-butadiene (SB) rubbers, styrene-isoprene (SI) rubbers, styrene-isoprene-styrene block copolymer (SIS) rubbers, styrene-butadiene-styrene block copolymer (SBS) rubbers, styrene-ethylene-butylene-styrene block copolymer (SEBS) rubbers, styrene-ethylene-propylene-styrene block copolymer (SEPS) rubbers, styrene-ethylene-isoprene-styrene block copolymer (SIPS) rubbers, and styrene-ethylene-propylene block copolymer (SEP) rubbers; polyisoprene rubbers; reclaimed rubbers; butyl rubbers (isobutylene-isoprene rubbers); polyisobutylenes; and modified substances derived from these rubbers. Among them, styrenic elastomer pressure-sensitive adhesives are preferred, of which SIS and SBS are more preferred. Each of these can be used alone or in combination as a mixture.

The urethane pressure-sensitive adhesives can be any known or common urethane pressure-sensitive adhesives without limitation, but preferred examples thereof include the urethane pressure-sensitive adhesives exemplified in Japanese Patent No. 3860880 and Japanese Unexamined Patent Application Publication (JP-A) No. 2006-288690. Among them, acrylic urethane pressure-sensitive adhesives composed of isocyanate/polyester polyols are more preferred. Of the acrylic urethane pressure-sensitive adhesives, preferred are expanded or foamed pressure-sensitive adhesives containing bubbles or foams, from the viewpoint of reducing skin irritation when the bag is applied directly to the skin. Such expanded pressure-sensitive adhesives can be prepared, for example, by a process of compounding a known or common blowing agent into a pressure-sensitive adhesive.

The pressure-sensitive adhesive may be any of pressure-sensitive adhesives of different forms, such as emulsion pressure-sensitive adhesives, solvent-containing pressure-sensitive adhesives, and thermofusible pressure-sensitive adhesives (hot-melt pressure-sensitive adhesives). Among them, thermofusible pressure-sensitive adhesives (hot-melt pressure-sensitive adhesives) are preferably used, because they can be directly applied through heating and melting without using solvents to form pressure-sensitive adhesive layers.

The pressure-sensitive adhesive for use herein can be any of pressure-sensitive adhesives of different types (properties), such as pressure-sensitive adhesives having heat curability (heat-curable pressure-sensitive adhesives), in which crosslinks or other structures are formed upon the application of heat, whereby the adhesives are cured; and pressure-sensitive adhesives having curability by the action of active energy rays (active-energy-ray-curable pressure-sensitive adhesives), in which crosslinks or other structures are formed upon the application of active energy rays, whereby the adhesives are cured. Among them, active-energy-ray-curable pressure-sensitive adhesives are preferred, because they can be free from solvents and are thereby not excessively impregnated into a nonwoven fabric or porous base. The heat-curable pressure-sensitive adhesives may further contain one or more of crosslinking agents and polymerization initiators for exhibiting heat curability as appropriate. The active-energy-ray-curable pressure-sensitive adhesives may further contain one or more of crosslinking agents and photoinitiators for exhibiting curability by the action of active energy rays as appropriate.

The pressure-sensitive adhesive layer may be protected by a known or common release film (separator) before use.

The bag-constituting member according to the present invention is used to form a bag through heat sealing. The heat sealing herein may be carried out using any procedure (device), but is preferably carried out through compression bonding with a heat sealer. The heat sealing in the compression bonding is performed at a temperature of preferably 90° C. to 250° C. and more preferably 130° C. to 200° C. and at a pressure of preferably 0.5 to 30 kg/cm² and more preferably 2.0 to 10 kg/cm², for a duration of preferably 0.02 to 1.0 second and more preferably 0.05 to 0.5 second.

When regular air-permeable bag-constituting members using porous films are heat-sealed under strong conditions (at a high heat-seal temperature, for a long heat-seal duration, and/or under a high heat-seal pressure), they are susceptible to edge tear, although they have high heat-seal strengths. In contrast, when the members are heat-sealed under weak conditions, they often show insufficient heat-seal strengths. In either case, a problem of product quality arises. To produce bags using these bag-constituting members, such process conditions that edge tear does not occur while the heat-seal strength is maintained (processable conditions) should be chosen. In industrial heat sealing processes, it generally takes a certain time from the beginning of processing to attaining of stable processing temperature. Typically, it takes a certain time for the processing temperature to reach equilibrium, because the work to be processed absorbs heat from the heat sealer during operation. Accordingly, when the processable conditions are small in range, problems arise such that it takes a long time from the beginning of processing to product acquisition and that large amounts of nonproduct portions are formed. In contrast, the bag-constituting member according to the present invention is resistant to edge tear even when heat-sealed under relatively strong conditions, thereby whose processable conditions are large in range (for example, the production can be started at a relatively high set temperature), and is advantageous in productivity and cost. As used herein the “edge tear” refers to a phenomenon in which the bag-constituting member after heat sealing tears at a boundary region 5 between a heat-sealed section and a non-heat-sealed section (see FIG. 3).

When the bag formed from the bag-constituting member according to the present invention is used as a disposable body warmer, the heat-seal strength of the heat-sealed section of the bag is preferably 5 N/25-mm or more and more preferably 8 N/25-mm or more, as measured in a T-peel test at a tensile speed of 300 mm/min. The bag can readily show such a high heat-seal strength particularly when the base polymer constituting the porous film further contains the ethylene-α-olefin copolymer.

The disposable body warmer according to the present invention is housed in an outer pouch and is sold as a body warmer product. A base material constituting the outer pouch is not particularly limited and can be any of, for example, plastic base materials; fibrous base materials such as nonwoven fabric base materials and woven fabric base materials made of fibers of every kind; and metallic base materials such as metal foil base materials made of metallic components of every kind. Among them, plastic base materials are preferably used as the base material. Examples of the plastic base materials include polyolefin base materials such as polypropylene base materials and polyethylene base materials; polyester base materials such as polyethylene terephthalate) base materials; styrenic base materials including polystyrene base materials, and styrenic copolymer base materials such as acrylonitrile-butadiene-styrene copolymer base materials; amide resin base materials; and acrylic resin base materials. The base material constituting the outer pouch may have a single layer structure or a multilayer structure. Though not critical, the thickness of the outer pouch is preferably 30 to 300 μm.

In a preferred embodiment, the outer pouch has a layer having gas barrier properties to inhibit permeation of gaseous components such as oxygen gas and water vapor (gas-barrier layer). The gas-barrier layer is not particularly limited, and examples thereof include oxygen-barrier resin layers such as those made of poly(vinylidene chloride) resins, ethylene-vinyl alcohol copolymers, poly(vinyl alcohol)s, and polyamide resins; water-vapor-barrier resin layers such as those made of polyolefins and poly(vinylidene chloride)s; and oxygen-barrier and/or water-vapor-barrier inorganic compound layers, including those made of elementary metals such as aluminum, and those made of metallic compounds including metal oxides such as silicon oxide and aluminum oxide. The gas-barrier layer may be a single layer (e.g., it may be the outer pouch base material itself) or a multilayer laminate.

The outer pouch may be a pouch of any form and structure, such as so-called “four-sided sealed pouch (four side seal pouch),” “three-sided sealed pouch (three side seal pouch),” “pillow style pouch,” “stand-up pouch” (“standing pouch”), or “gusseted pouch.” In a preferred embodiment, the outer pouch is a four-sided sealed pouch. The outer pouch may be prepared using an adhesive, but it is preferably prepared by heat sealing (thermofusing) as typically in a four-sided heat-sealed pouch.

### [Methods for Measurement of Properties and for Evaluation of Advantageous Effects]

Exemplary methods for the measurement and for the evaluation of advantageous effects adopted herein will be illustrated below.

### (1) Film Extrudability (Resin Pressure) of Porous Film

The melt viscosities of material mixtures according to the examples and comparative examples were measured with the “Capillograph 1C” supplied by Toyo Seiki Seisaku-Sho Ltd. under conditions of a temperature of 210° C. and a shearing speed of 10 (1/second). A sample having a melt viscosity of 6000 pascal-seconds (Pa·s) or less was evaluated as having good extrudability (A); a sample having a melt viscosity of more than 6000 Pa·s and 7000 Pa·s or less was evaluated as having somewhat poor extrudability (B); and a sample having a melt viscosity of more than 7000 Pa·s was evaluated as having poor extrudability (C).

### (2) Appearance (Uneven Stretching and Unmelted Substances) of Porous Film

Porous films (after stretching) prepared according to the examples and comparative examples were visually observed. A sample showing neither unmelted undesired substances such as fisheyes nor uneven stretching as horizontal stripes in a machine direction of the film (stripes extending in a direction perpendicular to the machine direction of the film) was evaluated as having good appearance (A); and a sample showing either of unmelted undesired substances or uneven stretching was evaluated as having poor appearance (C).

### (3) Edge Tear

Disposable body warmers were produced by the process according to the examples and comparative examples. One thousand and five hundred (1500) disposable body warmers were respectively produced within about 10 minutes from the beginning of the production. Whether or not and how edge tear occurs was visually observed in the produced disposable body warmers, and the edge tear was evaluated according to the following criteria:

Edge tear of 1 mm or more in length does not occur: No edge tear (A)

Edge tear of 1 mm or more in length occurs at a rate of less than 3%: Partial edge tear (B)

Edge tear of 1 mm or more in length occurs at a rate of 3% or more: Edge tear (C)

### (4) Heat-Seal Strength (Heat Sealing Strength)

The disposable body warmers prepared according to the examples and comparative examples were subjected to T-peel tests under conditions mentioned below to measure peel force, in which T-peel was performed between one bag-constituting member (composite member of a porous film and a nonwoven fabric) and the other bag-constituting member (“Nitotac”) as both ends. The measured peel force of a sample was defined as the heat-seal strength (N/25-mm).

Apparatus: “Shimadzu Autograph” supplied by Shimadzu Corporation

Sample width: 25 mm

Tensile speed: 300 mm/min

Tensile direction: Cross direction (CD; direction perpendicular to the machine direction (MD))

Ambient temperature and humidity: 23° C., relative humidity of 50%

Number of repeated tests: n=3

### (5) Weight-Average Molecular Weight (High-Temperature GPC Technique)

The respective samples were dissolved in o-dichlorobenzene with heating at 140° C. to give solutions. The solutions were filtrated through a sintered filter with a pore size of 1.0 μm, and the resulting filtrates were used as assay samples.

The weight-average molecular weights of the assay samples were measured with the gel permeation chromatograph “Alliance GPC 2000” (supplied by Waters Corporation) under the following conditions:

Separation columns: Two TSK-gel GMH₆-HT columns and two TSK-gel GMH₆-HTL columns (each 7.5 mm in inner diameter and 300 mm in length, supplied by Tosoh Corporation)

Column temperature: 140° C.

Mobile layer: o-Dichlorobenzene

Flow rate: 1.0 ml/min

Detector: Refractive index detector (RI)

Amount of injected sample: 400 μl

Molecular weight calibration: In terms of polystyrene (supplied by Tosoh Corporation)

### Examples

The present invention will be illustrated in further detail with reference to several working examples below. It should be noted, however, that these examples are never construed to limit the scope of the present invention.

A metallocene-catalyzed linear low-density polyethylene (metallocene-catalyzed LLDPE), an ethylene-α-olefin copolymer, and an ethylene-butene-diene terpolymer (EBT) used in the examples and comparative examples will be described in detail in Table 1.

### Example 1

A material mixture was prepared by melting and kneading polymer components, 150 parts by weight of calcium carbonate (inorganic microparticles) having an average particle diameter of 1.1 μm, and 1 part by weight of an antioxidant at 180° C. The polymer components contained 100 parts by weight of the metallocene-catalyzed linear low-density polyethylene (metallocene-catalyzed LLDPE), 20 parts by weight of the ethylene-α-olefin copolymer, and 20 parts by weight of an ultrahigh-molecular-weight polyethylene having a weight-average molecular weight of 79×10⁴, a MFR (190° C.) of 43 (g/10-min), and a density of 0.930 g/cm³.

The material mixture was melted and extruded at 210° C. using a single-screw extruder to give an unstretched film. Next, the unstretched film was stretched to be porous through uniaxial stretching using a roll at a stretching temperature of 80° C. in the machine direction (MD) to a draw ratio of 3.5 times and thereby yielded a porous film 70 μm thick.

Next, an amide hot-melt adhesive was applied in a mass of coating of 3 g/m² to a nylon spunbonded nonwoven fabric (mass per unit area: 35 g/m²) through spray coating, the porous film was affixed onto the coated adhesive, and thereby yielded a bag-constituting member (air-permeable bag-constituting member; bag-constituting member according to the present invention).

In addition, disposable body warmers were produced with a disposable body warmer marker.

As another bag-constituting member, a pressure-sensitive adhesive sheet for body warmer (“Nitotac” supplied by Nitto Lifetec Corporation) (non-air-permeable bag-constituting member) was used. The above-prepared bag-constituting member and the other bag-constituting member were respectively dispensed (fed) and inserted into between two heat-seal rolls while enclosing a heater therein so that the porous film surface of the air-permeable bag-constituting member faced the surface of the substrate film (surface opposite to the pressure-sensitive adhesive layer) of the non-air-permeable bag-constituting member. In this process, the line speed was controlled to be 5 m/min; and the two heat-seal rolls were respectively heated, in which the temperature of one roll facing the air-permeable bag-constituting member was set to be 145° C., and the temperature of the other roll facing the non-air-permeable bag-constituting member was set to be 160° C. Heat sealing was performed at a pressure between the heat-seal rolls of 7 kg/cm² to give disposable body warmers.

The disposable body warmers each had dimensions of 130 mm in the machine direction (MD; production line direction) and 95 mm in the cross direction (CD; direction perpendicular to the machine direction), whose four sides were heat-sealed in a width of 5 mm. The heater used herein was contents of a commercially available body warmer and was a mixture mainly containing an iron powder.

### Example 2

A porous film, a bag-constituting member, and disposable body warmers were produced by the procedure of Example 1, except for using, instead of the polymer components, 100 parts by weight of the metallocene-catalyzed LLDPE, 35 parts by weight of the ethylene-α-olefin copolymer, and 5 parts by weight of the ultrahigh-molecular-weight polyethylene having a weight-average molecular weight of 79×10⁴ as shown in Table 2.

### Example 3

A porous film, a bag-constituting member, and disposable body warmers were produced by the procedure of Example 1, except for using, instead of the ultrahigh-molecular-weight polyethylene, another ultrahigh-molecular-weight polyethylene having a weight-average molecular weight of 180×10⁴ as shown in Table 2.

### Example 4

A porous film, a bag-constituting member, and disposable body warmers were produced by the procedure of Example 1, except for using, instead of the ultrahigh-molecular-weight polyethylene, another ultrahigh-molecular-weight polyethylene having a weight-average molecular weight of 230×10⁴ as shown in Table 2.

### Example 5

A porous film, a bag-constituting member, and disposable body warmers were produced by the procedure of Example 1, except for using, instead of the polymer components, 70 parts by weight of the metallocene-catalyzed LLDPE, 10 parts by weight of the ethylene-α-olefin copolymer, and 60 parts by weight of the ultrahigh-molecular-weight polyethylene having a weight-average molecular weight of 79×10⁴ as shown in Table 2.

### Comparative Example 1

A porous film, a bag-constituting member, and disposable body warmers were produced by the procedure of Example 1, except for using, instead of the ultrahigh-molecular-weight polyethylene, a polyethylene having a weight-average molecular weight of 8×10⁴ as shown in Table 2.

### Comparative Example 2

A porous film, a bag-constituting member, and disposable body warmers were produced by the procedure of Example 1, except for using, instead of the ultrahigh-molecular-weight polyethylene, a polyethylene having a weight-average molecular weight of 300×10⁴ as shown in Table 2.

### Comparative Example 3

A porous film, a bag-constituting member, and disposable body warmers were produced by the procedure of Example 1, except for using, instead of the polymer components, 100 parts by weight of the metallocene-catalyzed LLDPE and 40 parts by weight of the ethylene-α-olefin copolymer without using the ultrahigh-molecular-weight polyethylene.

### Comparative Example 4

A porous film, a bag-constituting member, and disposable body warmers were produced by the procedure of Example 1, except for using, instead of the polymer components, 100 parts by weight of the metallocene-catalyzed LLDPE and 40 parts by weight of the ethylene-butene-diene terpolymer (EBT) without using the ultrahigh-molecular-weight polyethylene.

The porous films and disposable body warmers (bags) produced according to the examples and comparative examples were evaluated, and the results are shown in Table 2.

As is demonstrated by the data in Table 2, the porous films according to the present invention (Examples 1 to 4) show excellent quality without suffering from uneven stretching and unmelted undesired substances. The disposable body warmers (bags) produced from the porous films also show excellent quality without suffering from edge tear. The sample containing a large amount of the ultrahigh-molecular-weight polyethylene (Example 5) shows a high resin pressure and has poor extrudability, but the porous film and disposable body warmers produced therefrom show excellent quality.

In contrast, the samples using no ultrahigh-molecular-weight polyethylene (Comparative Examples 1, 3, and 4) suffer from uneven stretching and/or edge tear, and the resulting porous films and disposable body warmers show poor quality. The sample containing an ultrahigh-molecular-weight polyethylene having an excessively high molecular weight (Comparative Example 2) suffers from unmelted undesired substances, and the resulting porous film and disposable body warmers show poor quality.

TABLE 1

| | | Weight-average molecular | MFR (190° C.) | Density |
|---|---|---|---|---|
| | | weight | (g/10-min) | (g/cm³) |
| | | (High-temperature GPC) | (ISO 1133) | (ISO 1183) |
| Metallocene-catalyzed | Copolymer of ethylene and | 5 × 10⁴ to 6 × 10⁴ | 2.3 | 0.916 |
| LLDPE | hexene-1 | | | |
| Ethylene-α-olefin | Copolymer of ethylene and | 11 × 10⁴ | 3.6 | 0.885 |
| copolymer | butene-1 | | | |
| EBT | Terpolymer of ethylene, | 14 × 10⁴ | 2.0 | 0.893 |
| | butene-1, and diene | | | |

TABLE 2

| | | | | Evaluation of | | Evaluation of disposable | |
|---|---|---|---|---|---|---|---|
| | Ultrahigh-molecular-weight polyethylene | | | porous film | | body warmer | |
| | | Weight-average | | Film | | | Heat-seal |
| | | molecular weight | Content*1 | extrudability | | | strength |
| | | (High-temperature | (percent by | (Resin | | | (N/ |
| | | GPC) | weight) | pressure) | Appearance | Edge tear | 25-mm) |
| Example 1 | Ethylene-propylene copolymer | 79 × 10⁴ | 14.3 | A | A | A (none) | 17.3 |
| Example 2 | Ethylene-propylene copolymer | 79 × 10⁴ | 3.6 | A | A | A (none) | 15.0 |
| Example 3 | Ethylene-propylene copolymer | 180 × 10⁴ | 14.3 | A | A | A (none) | 13.3 |
| Example 4 | Ethylene-propylene copolymer | 230 × 10⁴ | 14.3 | A | A | A (none) | 15.1 |
| Example 5 | Ethylene-propylene copolymer | 79 × 10⁴ | 42.9 | C | A | A (none) | 20.9 |
| Com. Ex. 1 | Ethylene-propylene copolymer | 8 × 10⁴ | 14.3 | A | C (uneven stretching) | B (partial edge | 14.5 |
| | | | | | | tear) | |
| Com. Ex. 2 | Ethylene-propylene copolymer | 300 × 10⁴ | 14.3 | B | C (unmelted | A (none) | 23.2 |
| | | | | | substances) | | |
| Com. Ex. 3 | None | — | — | A | C (uneven stretching) | C (edge tear) | 14.3 |
| Com. Ex. 4 | None | — | — | A | A | C (edge tear) | 12.3 |

*1Contents are indicated based on the total amount of polymer components.

### INDUSTRIAL APPLICABILITY

The porous films for heat-sealable bag-constituting members according to the present invention have satisfactory productivity, good appearance, and high air permeability, because they are resistant to uneven stretching even when produced by stretching at low draw ratios. When the porous films are heat-sealed into bags, the bags show high seal strengths and are resistant to “edge tear” where the films tear at a boundary region between a heat-sealed section and a non-heat-sealed section. The porous films are thereby especially useful in bag-constituting members which will be heat-sealed into bags as, for example, disposable body warmers.

1. A porous film for a heat-sealable bag-constituting member, prepared by stretching an unstretched film to be porous, the porous film comprising an ultrahigh-molecular-weight polyethylene having a weight-average molecular weight of 30×10⁴ to 250×10⁴, a polyolefin component other than the ultrahigh-molecular-weight polyethylene, and an inorganic filler as essential components, wherein the content of the ultrahigh-molecular-weight polyethylene is 1 percent by weight or more based on the total amount of polymer components constituting the porous film.

2. The porous film for a heat-sealable bag-constituting member according to claim 1, wherein the polyolefin component other than the ultrahigh-molecular-weight polyethylene mainly comprises one polyolefin selected from the group consisting of a polypropylene, a linear low-density polyethylene having a weight-average molecular weight of less than 30×10⁴, and a high-density polyethylene having a weight-average molecular weight of less than 30×10⁴.

3. The porous film for a heat-sealable bag-constituting member according to claim 2, wherein the polyolefin component other than the ultrahigh-molecular-weight polyethylene further comprises an ethylene-α-olefin copolymer having a weight-average molecular weight of less than 30×10⁴ and a density of less than 0.90 g/cm³.

4. A heat-sealable bag-constituting member comprising a composite material including the porous film for a heat-sealable bag-constituting member according to claim 1 and another air-permeable material.

5. The heat-sealable bag-constituting member according to claim 4, adopted to at least one use selected from the group consisting of use for a disposable body warmer, use for housing a dehumidifier, use for housing a deodorant, use for housing a flavoring agent, and use for housing a deoxidizer.

6. A disposable body warmer comprising the heat-sealable bag-constituting member for a disposable body warmer, according to claim 5, as at least part of bag-constituting members.

7. A heat-sealable bag-constituting member comprising a composite material including the porous film for a heat-sealable bag-constituting member according to claim 2 and another air-permeable material.

8. A heat-sealable bag-constituting member comprising a composite material including the porous film for a heat-sealable bag-constituting member according to claim 3 and another air-permeable material.

9. The heat-sealable bag-constituting member according to claim 7, adopted to at least one use selected from the group consisting of use for a disposable body warmer, use for housing a dehumidifier, use for housing a deodorant, use for housing a flavoring agent, and use for housing a deoxidizer.

10. The heat-sealable bag-constituting member according to claim 8, adopted to at least one use selected from the group consisting of use for a disposable body warmer, use for housing a dehumidifier, use for housing a deodorant, use for housing a flavoring agent, and use for housing a deoxidizer.

11. A disposable body warmer comprising the heat-sealable bag-constituting member for a disposable body warmer, according to claim 9, as at least part of bag-constituting members.

12. A disposable body warmer comprising the heat-sealable bag-constituting member for a disposable body warmer, according to claim 10, as at least part of bag-constituting members.
